(19) United States
(12) Patent Application Publication
(10) Pub. No.: US 2021/0209194 A1
(43) Pub. Date: Jul. 8, 2021

(54) WHOLE NUMBER MATHEMATICAL IMAGE METHODS AND SYSTEMS

(71) Applicant: PATRICK MACDONALD, NAPANEE (CA)

(72) Inventor: PATRICK MACDONALD, NAPANEE (CA)

(21) Appl. No.: 17/143,323

(22) Filed: Jan. 7, 2021

Related U.S. Application Data
(60) Provisional application No. 62/957,930, filed on Jan. 7, 2020.

(51) Int. Cl. G06F 17/17

(52) U.S. Cl. CPC G06F 17/175

(57) ABSTRACT

Portable electronic devices, wearable devices, wireless networks provide access to applications including secure communications using encryption/decryption, financial transactions, medical information acquisition and transmittal, etc. These require low latency data access, secure communications, fast processing, etc. The result is a demand for improved mathematical processes for data storage, data processing, encryption/decryption of data, encoding/decoding data, etc. Embodiments of the invention establish a mathematical codex together with whole number mathematical image methods and systems applicable to such mathematical processes. Such whole number mathematical image methods and systems being applicable generally within computer science, medical science, science, engineering, mathematics, physics, and trinary languages.

### CROSS-REFERENCE TO RELATED APPLICATIONS

This patent application claims priority to U.S. Provisional Patent Application 62/957,930 entitled “Whole Number Mathematical Image Methods and Systems” filed Jan. 7, 2020, the entire contents of which are incorporated herein by reference.

### FIELD OF THE INVENTION

This patent application relates to a mathematical codex and more particularly to whole number mathematical image methods and systems applicable to mathematical processes within computer science, medical science, science, engineering, mathematics, physics, and trinary languages.

### BACKGROUND OF THE INVENTION

Mathematical processes and mathematical representations form an underpinning within a large number of fields including computer science, medical science, science, engineering, mathematics, physics etc. Within these fields, mathematical representations, and mathematical processes for the basis of decision processes, design processes, information processing, information storage, security through encryption/decryption, etc.

In the past 50 years microprocessor based computing systems have advanced dramatically from single core 8-bit 1 MHz processors (e.g., Intel™ 8008) to multi-core (e.g. 4, 6, 8) 64-bit 5 GHz processors (e.g. Intel™ Core™ i9-9900), memory has expanded from 1 kB DRAM (e.g. Intel™ 1103) to 32 Gb DRAM (e.g. Samsung K4AB series), and residential download speeds increased from 50 kb/s to 10 Mb/s or more. As such advanced applications from financial processing through to computer aided design/modelling/simulation etc. are accessible by hundreds of millions of users globally.

At the same time portable electronic devices, wearable devices, wireless networks now provide users with access to these capabilities enabling a wide range of applications to be supported including secure communications using encryption/decryption, financial transactions, medical information acquisition and transmittal, etc. Accordingly, user's expectations today are for low latency data access, secure communications, fast processing, etc. These continue unabated despite ongoing technology improvements as these enable new applications, advanced functionality, etc.

Accordingly, there is demand for improved mathematical processes for data storage, data processing, encryption/decryption of data, encoding/decoding data, etc. Beneficially, the inventor has established a mathematical codex and more particularly to whole number mathematical image methods and systems applicable to such mathematical processes. Beneficially, the whole number mathematical image methods and systems are applicable to applications generally within computer science, medical science, science, engineering, mathematics, physics, and trinary languages.

Other aspects and features of the present invention will become apparent to those ordinarily skilled in the art upon review of the following description of specific embodiments of the invention in conjunction with the accompanying figures.

### SUMMARY OF THE INVENTION

It is an object of the present invention to mitigate limitations within the prior art relating to mathematical processes by establishing a mathematical codex and more particularly to whole number mathematical image methods and systems applicable to mathematical processes within computer science, medical science, science, engineering, mathematics, physics, and trinary languages.

In accordance with an embodiment of the invention there is provided a system comprising:
a microprocessor;
a non-volatile, non-transitory storage medium storing computer executable instructions; wherein
the computer executable instructions when executed by the microprocessor automatically execute one or more processes upon data accessible to the microprocessor; and
each process of the one or more processes employs a predetermined portion of a codex.

In accordance with an embodiment of the invention there is provided a non-volatile, non-transitory storage medium storing computer executable instructions for execution by a microprocessor, the computer executable instructions when executed by the microprocessor configuring the microprocessor to automatically execute one or more processes upon data accessible to the microprocessor, wherein each process of the one or more processes employs a predetermined portion of a codex.

In accordance with an embodiment of the invention the predetermined portion of the codex employed by the mathematical process is either a whole number mathematical image representation or a plurality of S lower sequences and a plurality T threads wherein each lower sequence of the plurality of S lower sequences and each thread of the plurality T threads comprises a recurring sequence of nine numbers where each number is an integer N, S=6 and T=3.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts examples of assigning variable levels to different numeric values;

FIG. 2 depicts twelve thread sequences obtained through reduction using Verdic digital roots and as upper thread sequence and lower thread sequences according to an embodiment of the invention together with three threads (the lower thread sequences forming part of a MacDonald Codex according to an embodiment of the invention);

FIG. 3 depicts the alternate lower sequences established by the inventor according to an embodiment of the invention as threads forming part of the MacDonald Codex;

FIG. 4 depicts the alternate lower sequences according to FIG. 3 depicted vertically;

FIG. 5 depicts a prior art Vedic square;

FIG. 6 a mathematical pattern the inventor refers to as the “language of the Universe”;

FIG. 7 depicts the result of adding each set of three consecutive numbers in the mathematical pattern of FIG. 6 and reducing the results to digital roots;

FIG. 8 depicts the sequence 1 and 4 according to the MacDonald Codex according to embodiments of the invention;

FIG. 9 depicts the sequence 2 and 5 according to the MacDonald Codex according to embodiments of the invention;

FIG. 10 depicts the sequence 3 and 6 according to the MacDonald Codex according to embodiments of the invention;

FIG. 11 depicts the first lower sequence 147 according to the MacDonald Codex according to embodiments of the invention;

FIG. 12 depicts the second lower sequence 369 according to the MacDonald Codex according to embodiments of the invention;

FIG. 13 depicts the third lower sequence 258 according to the MacDonald Codex according to embodiments of the invention;

FIG. 14 depicts the fourth lower sequence 147 according to the MacDonald Codex according to embodiments of the invention;

FIG. 15 depicts the fifth lower sequence 369 according to the MacDonald Codex according to embodiments of the invention;

FIG. 16 depicts the sixth lower sequence 258 according to the MacDonald Codex according to embodiments of the invention;

FIG. 17 depicts the first lower sequence 147 according to the MacDonald Codex according to embodiments of the invention modified for improved visibility;

FIG. 18 depicts the second lower sequence 369 according to the MacDonald Codex according to embodiments of the invention modified for improved visibility;

FIG. 19 depicts the third lower sequence 258 according to the MacDonald Codex according to embodiments of the invention modified for improved visibility;

FIG. 20 depicts the fourth lower sequence 147 according to the MacDonald Codex according to embodiments of the invention modified for improved visibility;

FIG. 21 depicts the fifth lower sequence 369 according to the MacDonald Codex according to embodiments of the invention modified for improved visibility;

FIG. 22 depicts the sixth lower sequence 258 according to the MacDonald Codex according to embodiments of the invention modified for improved visibility;

FIG. 23 depicts an exemplary network within which devices and/or systems exploiting embodiments of the invention may be deployed;

FIG. 24 depicts an exemplary electronic device exploiting embodiments of the invention; and

FIG. 25 depicts an exemplary application of an embodiment of the invention to an electrical motor.

### DETAILED DESCRIPTION

The present description is directed to a mathematical codex and more particularly to whole number mathematical image methods and systems applicable to mathematical processes within computer science, medical science, science, engineering, mathematics, physics, and trinary languages.

The ensuing description provides representative embodiment(s) only, and is not intended to limit the scope, applicability, or configuration of the disclosure. Rather, the ensuing description of the embodiment(s) will provide those skilled in the art with an enabling description for implementing an embodiment or embodiments of the invention. It being understood that various changes can be made in the function and arrangement of elements without departing from the spirit and scope as set forth in the appended claims. Accordingly, an embodiment is an example or implementation of the inventions and not the sole implementation. Various appearances of “one embodiment,” “an embodiment” or “some embodiments” do not necessarily all refer to the same embodiments. Although various features of the invention may be described in the context of a single embodiment, the features may also be provided separately or in any suitable combination. Conversely, although the invention may be described herein in the context of separate embodiments for clarity, the invention can also be implemented in a single embodiment or any combination of embodiments.

Reference in the specification to “one embodiment”, “an embodiment”, “some embodiments” or “other embodiments” means that a particular feature, structure, or characteristic described in connection with the embodiments is included in at least one embodiment, but not necessarily all embodiments, of the inventions. The phraseology and terminology employed herein is not to be construed as limiting but is for descriptive purpose only. It is to be understood that where the claims or specification refer to “a” or “an” element, such reference is not to be construed as there being only one of that element. It is to be understood that where the specification states that a component feature, structure, or characteristic “may”, “might”, “can” or “could” be included, that particular component, feature, structure, or characteristic is not required to be included.

Reference to terms such as “left”, “right”, “top”, “bottom”, “front” and “back” are intended for use in respect to the orientation of the particular feature, structure, or element within the figures depicting embodiments of the invention. It would be evident that such directional terminology with respect to the actual use of a device has no specific meaning as the device can be employed in a multiplicity of orientations by the user or users.

Reference to terms “including”, “comprising”, “consisting” and grammatical variants thereof do not preclude the addition of one or more components, features, steps, integers, or groups thereof and that the terms are not to be construed as specifying components, features, steps, or integers. Likewise, the phrase “consisting essentially of”, and grammatical variants thereof, when used herein is not to be construed as excluding additional components, steps, features integers or groups thereof but rather that the additional features, integers, steps, components, or groups thereof do not materially alter the basic and novel characteristics of the claimed composition, device, or method. If the specification or claims refer to “an additional” element, that does not preclude there being more than one of the additional element.

A “portable electronic device” (PED) as used herein and throughout this disclosure, refers to a wireless device used for communications and other applications that requires a battery or other independent form of energy for power. This includes devices, but is not limited to, such as a cellular telephone, smartphone, personal digital assistant (PDA), portable computer, pager, portable multimedia player, portable gaming console, laptop computer, tablet computer, a wearable device, and an electronic reader.

A “fixed electronic device” (FED) as used herein and throughout this disclosure, refers to a wireless and/or wired device used for communications and other applications that requires connection to a fixed interface to obtain power. This includes, but is not limited to, a laptop computer, a personal computer, a computer server, a kiosk, a gaming console, a digital set-top box, an analog set-top box, an Internet enabled appliance, an Internet enabled television, and a multimedia player.

A “server” as used herein, and throughout this disclosure, refers to one or more physical computers co-located and/or geographically distributed running one or more services as a host to users of other computers, PEDs, FEDs, etc. to serve the client needs of these other users. This includes, but is not limited to, a database server, file server, mail server, print server, web server, gaming server, or virtual environment server.

An “application” (commonly referred to as an “app”) as used herein may refer to, but is not limited to, a “software application”, an element of a “software suite”, a computer program designed to allow an individual to perform an activity, a computer program designed to allow an electronic device to perform an activity, and a computer program designed to communicate with local and/or remote electronic devices. An application thus differs from an operating system (which runs a computer), a utility (which performs maintenance or general-purpose chores), and a programming tools (with which computer programs are created). Generally, within the following description with respect to embodiments of the invention an application is generally presented in respect of software permanently and/or temporarily installed upon a PED and/or FED.

An “enterprise” as used herein may refer to, but is not limited to, a provider of a service and/or a product to a user, customer, or consumer. This includes, but is not limited to, a retail outlet, a store, a market, an online marketplace, a manufacturer, an online retailer, a charity, a utility, and a service provider. Such enterprises may be directly owned and controlled by a company or may be owned and operated by a franchisee under the direction and management of a franchiser.

A “service provider” as used herein may refer to, but is not limited to, a third party provider of a service and/or a product to an enterprise and/or individual and/or group of individuals and/or a device comprising a microprocessor. This includes, but is not limited to, a retail outlet, a store, a market, an online marketplace, a manufacturer, an online retailer, a utility, an own brand provider, and a service provider wherein the service and/or product is at least one of marketed, sold, offered, and distributed by the enterprise solely or in addition to the service provider.

A “third party” or “third party provider” as used herein may refer to, but is not limited to, a so-called “arm's length” provider of a service and/or a product to an enterprise and/or individual and/or group of individuals and/or a device comprising a microprocessor wherein the consumer and/or customer engages the third party but the actual service and/or product that they are interested in and/or purchase and/or receive is provided through an enterprise and/or service provider.

A “user” as used herein may refer to, but is not limited to, an individual or group of individuals. This includes, but is not limited to, private individuals, employees of organizations and/or enterprises, members of community organizations, members of charity organizations, men, and women. In its broadest sense the user may further include, but not be limited to, software systems, mechanical systems, robotic systems, android systems, etc. that may be characterised by an ability to exploit one or more embodiments of the invention. A user may also be associated through one or more accounts and/or profiles with one or more of a service provider, third party provider, enterprise, social network, social media etc. via a dashboard, web service, website, software plug-in, software application, and graphical user interface.

“Biometric” information as used herein may refer to, but is not limited to, data relating to a user characterised by data relating to a subset of conditions including, but not limited to, their environment, medical condition, biological condition, physiological condition, chemical condition, ambient environment condition, position condition, neurological condition, drug condition, and one or more specific aspects of one or more of these said conditions. Accordingly, such biometric information may include, but not be limited, blood oxygenation, blood pressure, blood flow rate, heart rate, temperate, fluidic pH, viscosity, particulate content, solids content, altitude, vibration, motion, perspiration, EEG, ECG, energy level, etc. In addition, biometric information may include data relating to physiological characteristics related to the shape and/or condition of the body wherein examples may include, but are not limited to, fingerprint, facial geometry, baldness, DNA, hand geometry, odour, and scent. Biometric information may also include data relating to behavioral characteristics, including but not limited to, typing rhythm, gait, and voice.

“User information” as used herein may refer to, but is not limited to, user behavior information and/or user profile information. It may also include a user's biometric information, an estimation of the user's biometric information, or a projection/prediction of a user's biometric information derived from current and/or historical biometric information.

A “wearable device” or “wearable sensor” relates to miniature electronic devices that are worn by the user including those under, within, with or on top of clothing and are part of a broader general class of wearable technology which includes “wearable computers” which in contrast are directed to general or special purpose information technologies and media development. Such wearable devices and/or wearable sensors may include, but not be limited to, smartphones, smart watches, e-textiles, smart shirts, activity trackers, smart glasses, environmental sensors, medical sensors, biological sensors, physiological sensors, chemical sensors, ambient environment sensors, position sensors, neurological sensors, drug delivery systems, medical testing and diagnosis devices, and motion sensors.

“Electronic content” (also referred to as “content” or “digital content”) as used herein may refer to, but is not limited to, any type of content that exists in the form of digital data as stored, transmitted, received and/or converted wherein one or more of these steps may be analog although generally these steps will be digital. Forms of digital content include, but are not limited to, information that is digitally broadcast, streamed, or contained in discrete files. Viewed narrowly, types of digital content include popular media types such as MP3, JPG, AVI, TIFF, AAC, TXT, RTF, HTML, XHTML, PDF, XLS, SVG, WMA, MP4, FLV, and PPT, for example, as well as others, see for example http://en.wikipedia.org/wiki/List of file formats. Within a broader approach digital content mat include any type of digital information, e.g., digitally updated weather forecast, a GPS map, an eBook, a photograph, a video, a Vine™, a blog posting, a Facebook™ posting, a Twitter™ tweet, online TV, etc. The digital content may be any digital data that is at least one of generated, selected, created, modified, and transmitted in response to a user request, said request may be a query, a search, a trigger, an alarm, and a message for example.

A “profile” as used herein, and throughout this disclosure, refers to a computer and/or microprocessor readable data file comprising data relating to settings and/or limits of an adult device. Such profiles may be established by a manufacturer/supplier/provider of a device, service, etc. or they may be established by a user through a user interface for a device, a service, or a PED/FED in communication with a device, another device, a server, or a service provider etc.

A “computer file” (commonly known as a file) as used herein, and throughout this disclosure, refers to a computer resource for recording data discretely in a computer storage device, this data being electronic content. A file may be defined by one of different types of computer files, designed for different purposes. A file may be designed to store electronic content such as a written message, a video, a computer program, or a wide variety of other kinds of data. Some types of files can store several types of information at once. A file can be opened, read, modified, copied, and closed with one or more software applications an arbitrary number of times. Typically, files are organized in a file system which can be used on numerous different types of storage device exploiting different kinds of media which keeps track of where the files are located on the storage device(s) and enables user access. The format of a file is defined by its content since a file is solely a container for data, although, on some platforms the format is usually indicated by its filename extension, specifying the rules for how the bytes must be organized and interpreted meaningfully. For example, the bytes of a plain text file are associated with either ASCII or UTF-8 characters, while the bytes of image, video, and audio files are interpreted otherwise. Some file types also allocate a few bytes for metadata, which allows a file to carry some basic information about itself.

“Metadata” as used herein, and throughout this disclosure, refers to information stored as data that provides information about other data. Many distinct types of metadata exist, including but not limited to, descriptive metadata, structural metadata, administrative metadata, reference metadata and statistical metadata. Descriptive metadata may describe a resource for purposes such as discovery and identification and may include, but not be limited to, elements such as title, abstract, author, and keywords. Structural metadata relates to containers of data and indicates how compound objects are assembled and may include, but not be limited to, how pages are ordered to form chapters, and typically describes the types, versions, relationships, and other characteristics of digital materials. Administrative metadata may provide information employed in managing a resource and may include, but not be limited to, when and how it was created, file type, technical information, and who can access it. Reference metadata may describe the contents and quality of statistical data whereas statistical metadata may also describe processes that collect, process, or produce statistical data. Statistical metadata may also be referred to as process data.

Mathematical processes and mathematical representations form an underpinning within a large number of fields including computer science, medical science, science, engineering, mathematics, physics etc. Within these fields, mathematical representations, and mathematical processes for the basis of decision processes, design processes, information processing, information storage, security through encryption/decryption, etc.

In the past 50 years microprocessor based computing systems have advanced dramatically from single core 8-bit 1 MHz processors (e.g., Intel™ 8008) to multi-core (e.g. 4, 6, 8) 64-bit 5 GHz processors (e.g. Intel™ Core™ i9-9900), memory has expanded from 1 kB DRAM (e.g. Intel™ 1103) to 32 Gb DRAM (e.g. Samsung™ K4AB series) and residential download speeds increased from 50 kb/s to 10 Mb/s or more. As such advanced applications from financial processing through to computer aided design/modelling/simulation etc. are accessible by hundreds of millions of users globally.

At the same time portable electronic devices, wearable devices, wireless networks now provide users with access to these capabilities enabling a wide range of applications to be supported including secure communications using encryption/decryption, financial transactions, medical information acquisition and transmittal, etc. Accordingly, user's expectations today are for low latency data access, secure communications, fast processing, etc. These continue unabated despite ongoing technology improvements as these enable new applications, advanced functionality, etc.

Accordingly, there is demand for improved mathematical processes for data storage, data processing, encryption/decryption of data, encoding/decoding data, etc. Beneficially, the inventor has established a mathematical codex and more particularly to whole number mathematical image methods and systems applicable to such mathematical processes. Beneficially, the whole number mathematical image methods and systems are applicable to applications generally within computer science, medical science, science, engineering, mathematics, physics, and trinary languages.

The inventor in establishing these whole number mathematical image methods and systems according to embodiments of the invention has exploited a trinary language with three threads. Initially, referring to FIG. 1 there are presented alternate trinary languages. Whilst digital processes today exploit binary representations of data the data it represents is not. If, we consider the underlying world view then it is in essence a trinary engine with three “threads.” To explain this then we can consider several simple trinary language representations of the world. Language A comprises trinary representations “+1”, “0” and “−1” respectively whilst Language B comprises trinary representations “Dark”, “Light+Dark” and “Light.” Language C comprises trinary representations “Negative”, “Neutral”, and “Positive.” Such representations explain our world quite well relative to any particular threshold. Further, opposites attract whilst likes or equals oppose. For example, a +1 positive charge will attract a −1 positive charge and cancel out.

The inventor has also added fourth and fifth languages, Language D, comprising “3”, “9” and “6” whilst Language E comprises “147”, “369” and “258.” To explain the inclusion of Language D the inventor refers to Vedic math, or more specifically, the Vedic digital root. To find a Vedic digital root, take any number over 10 is reduced it to a single digital root. For example, 12 becomes 1+2=3 or 10 becomes 1+0=1. Accordingly, if we consider Language E comprising “147”, “369” and “258” then the relationships given by Equations (1) to (3) result.

1+4+7=12⇒1+2=3 (1)

2+5+8=15⇒1+5=6 (2)

3+6+9=18⇒1+8=9 (3)

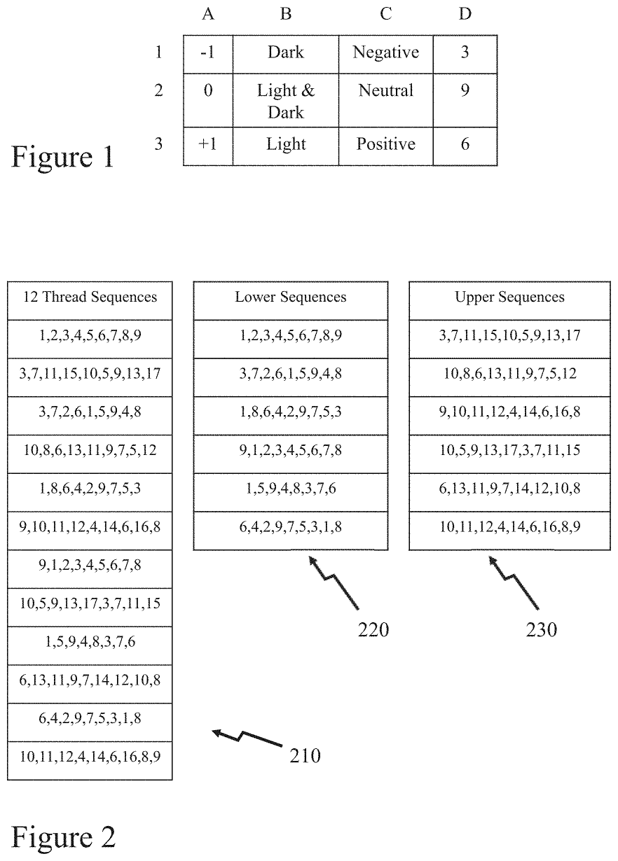

Now referring to FIG. 2 there are depicted twelve thread sequences obtained through reduction using Verdic digital roots and as upper and lower thread sequences which form the basis of a codex (MacDonald Codex) according to an embodiment of the invention together with three threads. If we consider, the repeating numerical sequence 1,2,3,4,5,6,7,8,9,1,2,3,4,5,6,7,8,9 . . . then this represents the first of the 12 thread sequence depicted in first table 210 in FIG. 2 and is referred to as the lower sequence by the inventor. If this is taken in sequence in pairs then we obtain the relationships in Equation (4) which yields the second sequence given by Equation (5). This is the second sequence in first table 210.

1+2,3+4,5+6,7+8,9+1,2+3,4+5,6+7,8+9, . . . (4)

3,7,11,15,10,5,9,13,17 (5)

3,7,2,6,1,5,9,4,8 (6)

Reducing the sequence in Equation (5) further using the Vedic digital root leads to a second sequence of which the first nine numbers are given by Equation (6) which is the second sequence in first table 210 in FIG. 2. Repeating the Vedic digital root again leads to a third sequence of which the first nine numbers are given by Equation (6) which is the third sequence in first table 210 in FIG. 2. The inventor then repeats this process until it repeats resulting in the fourth to twelfth sequences of which the first nine numbers are given in Equations (7) to (15) below and are depicted as the fourth to twelfth sequences in first table 210 in FIG. 2. According, applying the Vedic digital root process again to the twelfth sequence in Equation (15) would result in 1,2,3,4,5,6,7,8,9 . . . which is where we began with the first sequence.

10,8,6,13,11,9,7,5,12 (7)

1,8,6,4,2,9,7,5,3 (8)

9,10,11,12,4,14,6,16,8 (9)

9,1,2,3,4,5,6,7,8 (10)

10,5,9,13,17,3,7,11,15 (11)

1,5,9,4,8,3,7,2,6 (12)

6,13,11,9,7,14,12,10,8 (13)

6,4,2,9,7,5,3,1,8 (14)

10,11,12,4,14,6,16,8,9 (15)

The inventor then separates these into what they refer to as lower sequences and upper sequences. The six lower sequences being sequences as given by the initial sequence of 123456789 and Equations (2), (6), (8), (10), (12) and (14) all contain only single digit components and are depicted in second table 220 in FIG. 2. The six upper sequences being those given by Equations (5), (7), (9), (11), (13), and (15) and contain either single- or double-digit components as depicted in third table 230 in FIG. 2. Accordingly, the inventor refers to these twelve sequences as the twelve threads, namely the sequences given by Equations (2) and (5)-(15) respectively established by sequentially performing Vedic digital root processes on the original recurring thread, 123456789, until the thread re-appears.

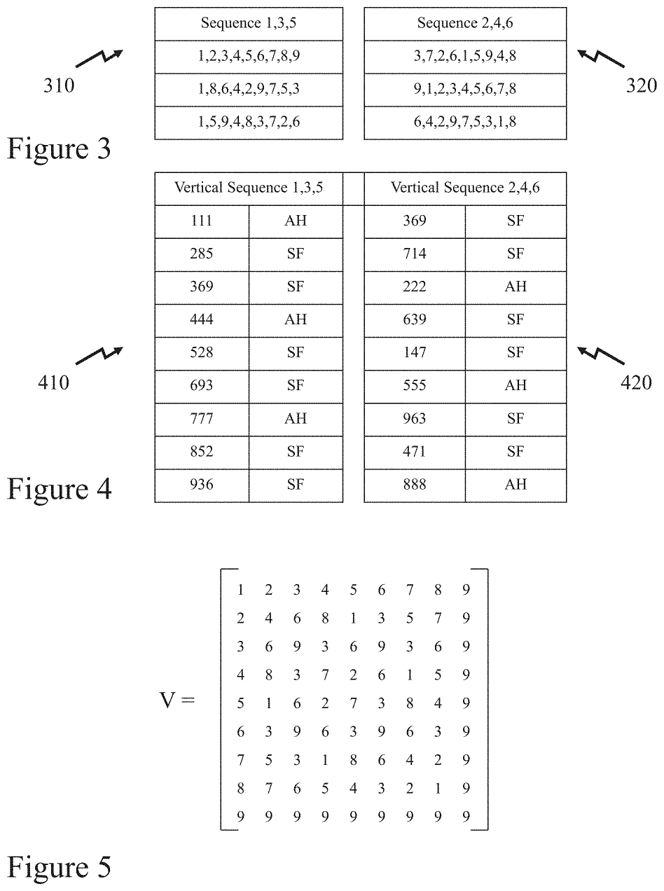

The inventor then took each alternate lower sequence beginning with a “1” in second table 220 in FIG. 2 to yield what the inventor refers to as the “Sequences 1,3,5”, as depicted in first table 310 in FIG. 3. The other sequences from the lower sequences depicted in second table 220 in FIG. 2 to yield what the inventor refers to as the “Sequences 2,4,6”, as depicted in second table 320 in FIG. 3.

Next, the inventor took sequentially the N^{th} digit of each of the “Sequences 1,3,5” in first table 310 in FIG. 3 resulting in the first vertical sequence depicted in first table 410 in FIG. 4 which the inventor refers to as “Vertical Sequences 1,3,5.” Adjacent to each three-digit sequence is a code, either “AH” or “SF”, which are short forms for references employed by the inventor of “Angelic Harmonics” and “Solfeggio Frequencies.” This is also depicted for the “Sequences 2,4,6” in second table 320 in FIG. 3 resulting in the second vertical sequence depicted in second table 420 in FIG. 4.

The inventor refers to the six lower sequences, depicted in second table 220 in FIG. 2, and the three threads, “Sequences 1,3,5” depicted in first table 310 in FIG. 3, as the MacDonald Codex.

Now referring to FIG. 5 the inventor depicts what is known as a Vedic square within the prior art. The inventor notes that the six lower sequences and the three threads of the MacDonald Codex according to an embodiment of the invention may be identified within the Vedic square.

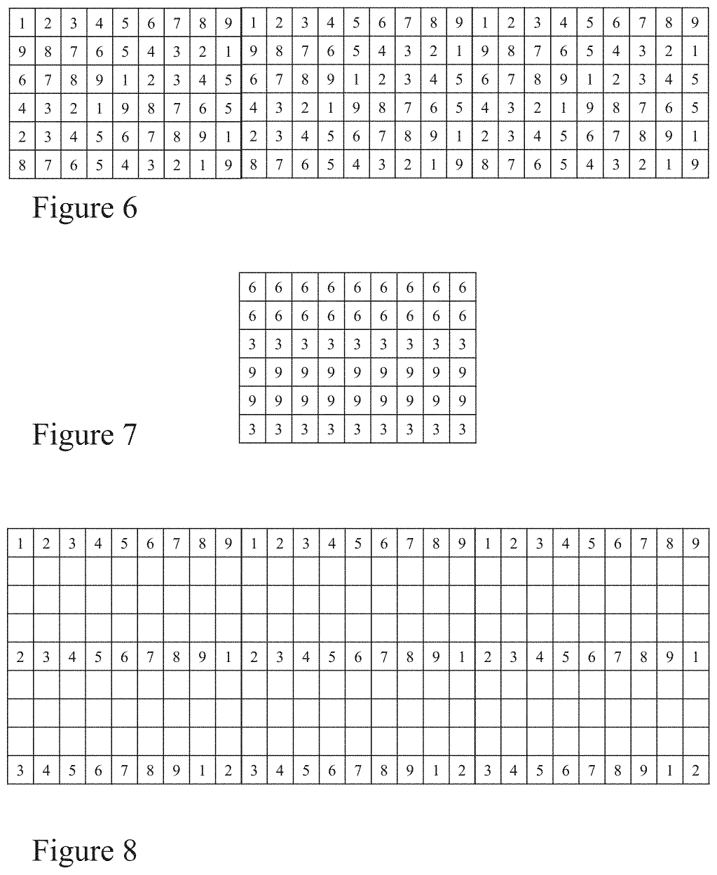

Further, the inventor notes that the six lower sequences of the MacDonald Codex according to an embodiment of the invention reduce to 3, 6, 9; a trinary language. Accordingly, referring to FIG. 6 there are depicted the six lower sequences of the MacDonald Codex according to an embodiment of the invention replicated three times across the width of the depicted array. Starting, at the top left, add the first three consecutive numbers together and then reduce this number to its Vedic digital root. Next, continue to the second line from the top and add the corresponding three consecutive numbers and reduce this number to its Vedic digital root. Continuing this through for the whole of the MacDonald Codex according to an embodiment of the invention results in the table presented in FIG. 7. When added in this manner for all pages of the codex then we come back to a trinary language as all numbers are either a 3, 9, or 6.

The inventor notes that whilst this description begins at the top left of the array the same result can be obtained by starting anywhere on the top line.

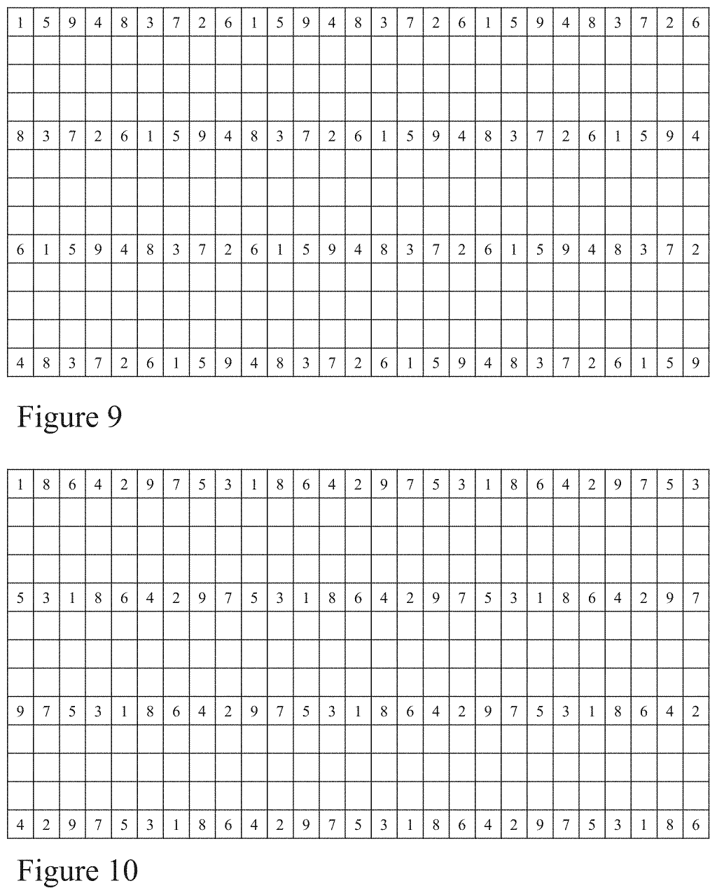

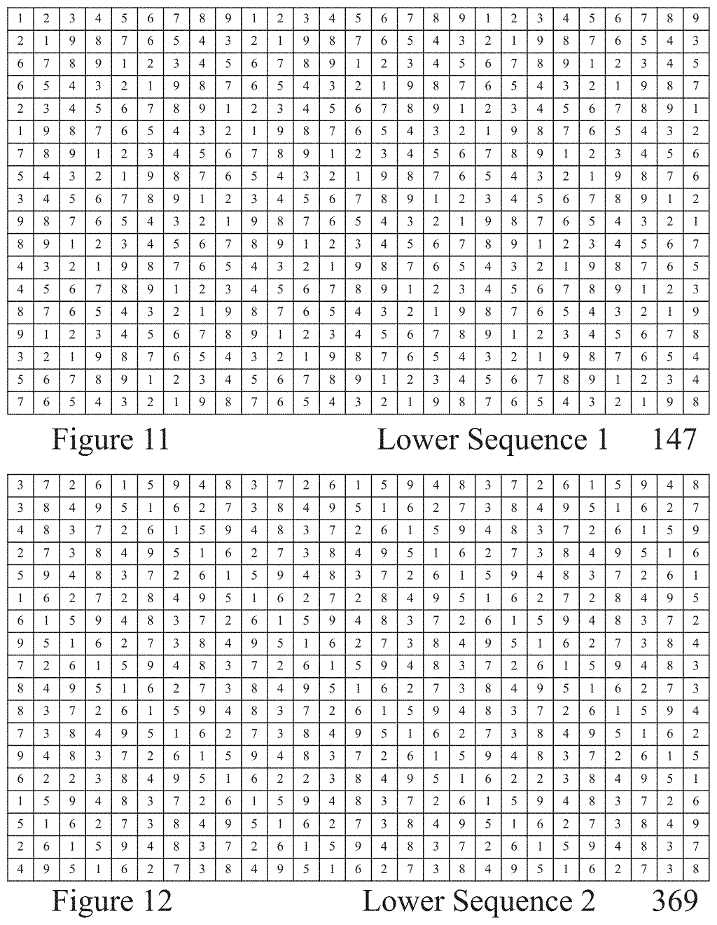

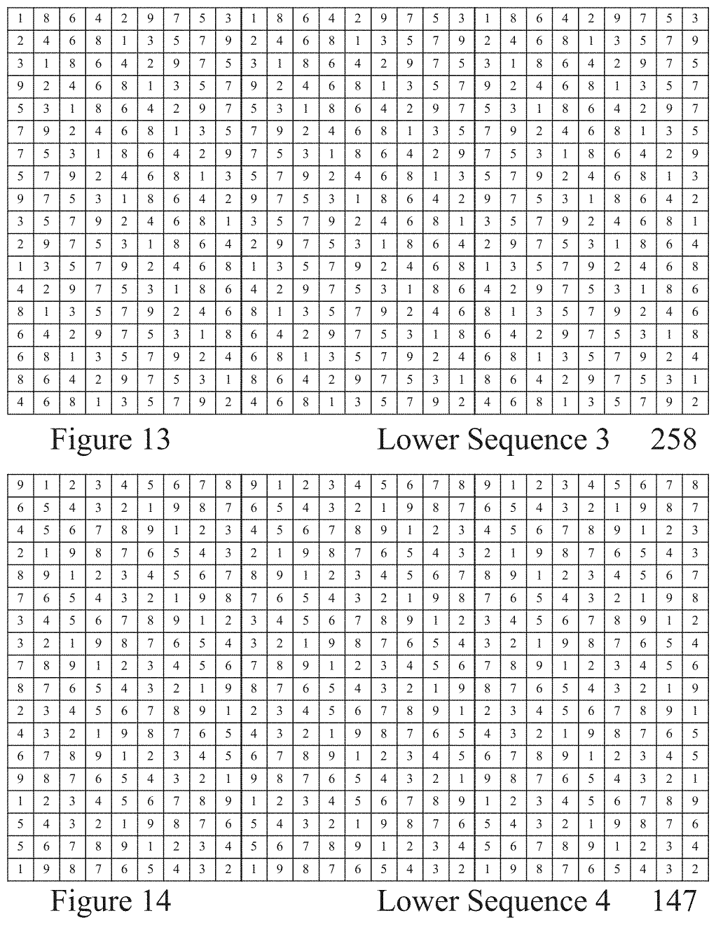

The inventor refers to the MacDonald Codex as a whole number mathematical image of the Universe. The inventor notes that within the prior art Dr Joseph Puleo is reputed to have discovered a code within the Book of Numbers, the Book of Numbers being the fourth book of the Hebrew Bible, and the fourth of five books of the Jewish Torah. This code being 123456789-147-258-369. Referring to FIGS. 8 to 10 respectively there are depicted pages of the MacDonald Codex where each page is specifically designed so that the 147, 258, and 369 numbers are all in tandem with each other. These are generated using a four-count step where the sequences count from 1 to 9. Within FIG. 9 for the sequence 2 and 5 where the vertical sequence is 135792468 whilst horizontally it is the 159843726 sequence. Within FIG. 10 for the sequence 3 and 6 the vertical sequence is 159483726 whilst the horizontal sequence is 135792468.

FIG. 11 depicts a page of the MacDonald Codex beginning with the first lower sequence (lower sequence 1) 123456789 for 147.

FIG. 12 depicts a page of the MacDonald Codex beginning with the second lower sequence (lower sequence 2) 372615948 for 369.

FIG. 13 depicts a page of the MacDonald Codex beginning with the third lower sequence (lower sequence 3) 186429753 for 258.

FIG. 14 depicts a page of the MacDonald Codex beginning with the fourth lower sequence (lower sequence 4) 912345678 for 147.

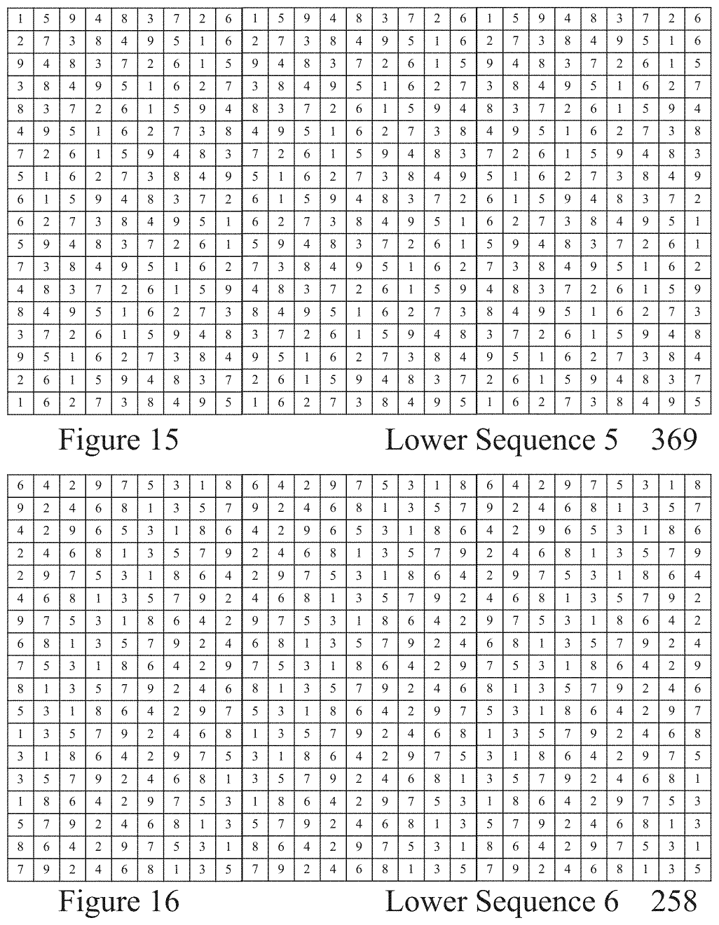

FIG. 15 depicts a page of the MacDonald Codex beginning with the fifth lower sequence (lower sequence 5) 159483726 for 369.

FIG. 16 depicts a page of the MacDonald Codex beginning with the sixth lower sequence (lower sequence 6) 642975318 for 258.

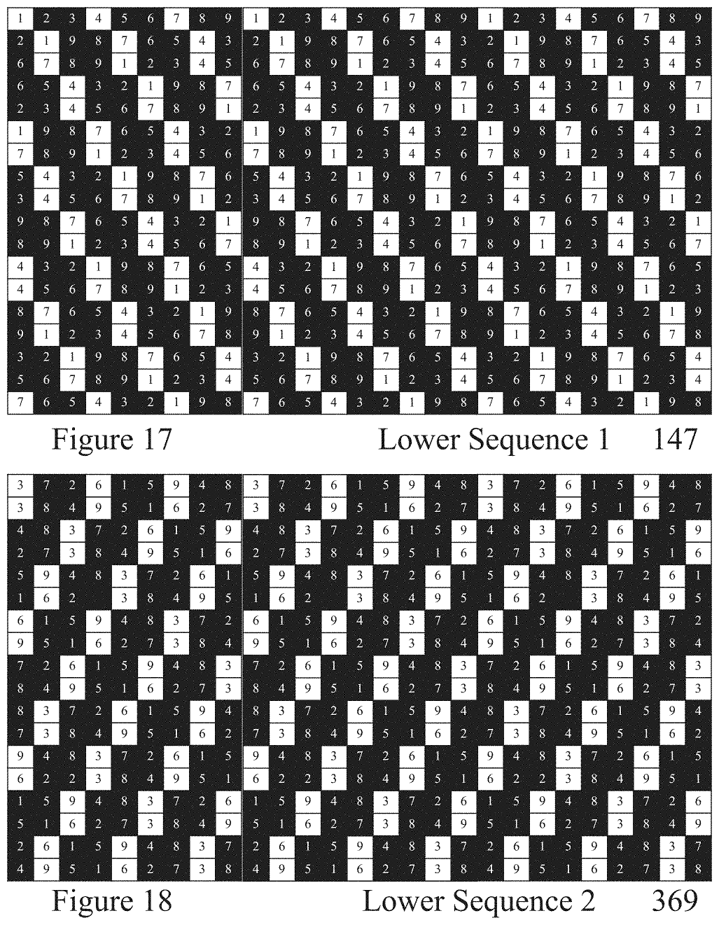

FIG. 17 depicts a page of the MacDonald Codex beginning with the first lower sequence (lower sequence 1) 123456789 highlighted for clarity of the 147 pattern.

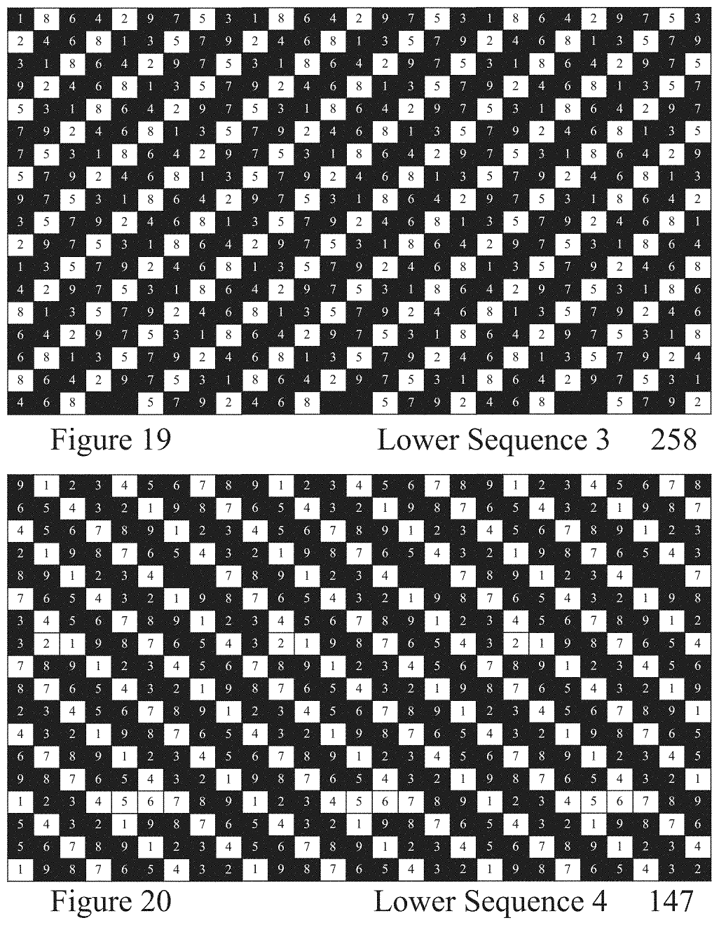

FIG. 18 depicts a page of the MacDonald Codex beginning with the second lower sequence (lower sequence 2) 372615948 highlighted for clarity of the 369 pattern.

FIG. 19 depicts a page of the MacDonald Codex beginning with the third lower sequence (lower sequence 3) 186429753 highlighted for clarity of the 258 pattern.

FIG. 20 depicts a page of the MacDonald Codex beginning with the fourth lower sequence (lower sequence 4) 912345678 highlighted for clarity of the 147 pattern.

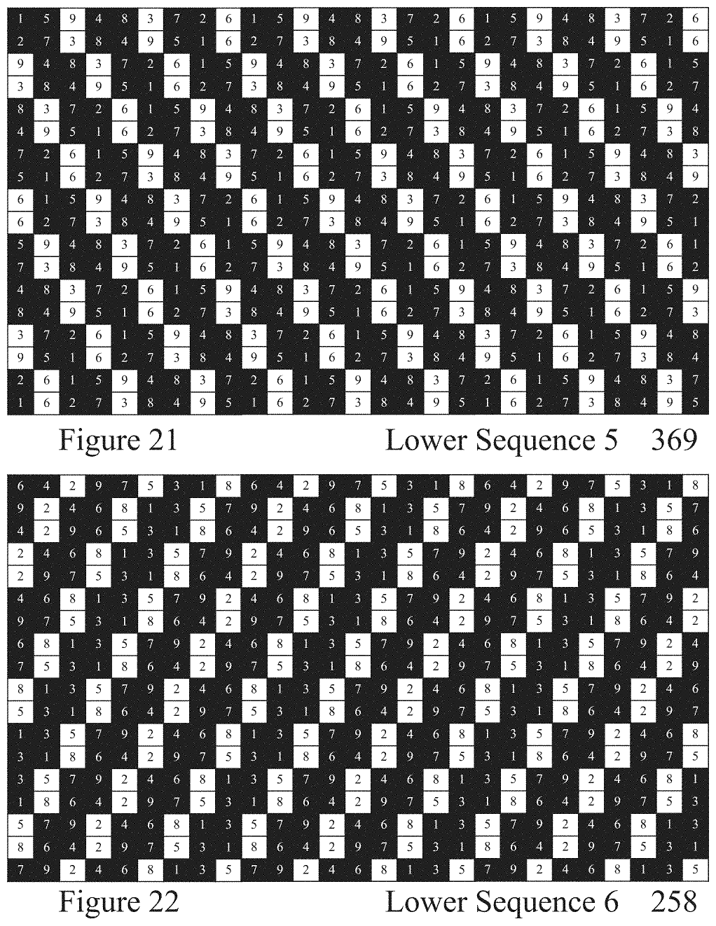

FIG. 21 depicts a page of the MacDonald Codex beginning with the fifth lower sequence (lower sequence 5) 159483726 highlighted for clarity of the 369 pattern.

FIG. 22 depicts a page of the MacDonald Codex beginning with the sixth lower sequence (lower sequence 6) 642975318 highlighted for clarity of the 258 pattern.

The MacDonald Codex allows for improved mathematical processes for data storage, data processing, encryption/decryption of data, encoding/decoding data, etc. The MacDonald Codex represents a whole number mathematical image. This mathematical image may be employed within a variety of mathematical processes within a range of applications within computer science, medical science, science, engineering, mathematics, physics, and trinary languages. The MacDonald Codex may be executed upon one or more electronic devices selected from a PED, a FED, a wearable device etc. The MacDonald Codex may be stored within the electronic device, stored within a memory accessible to the electronic device, or stored within a memory remotely accessible to the electronic device. A software application accessing the MacDonald Codex may be in execution upon the electronic device, in execution upon another electronic device accessible to the electronic device, or in execution upon a remote server accessible to the electronic device.

Accordingly, within an embodiment of the invention a page of the MacDonald Codex, a predetermined portion of a page of the MacDonald Codex, multiple pages of the MacDonald Codex, predetermined portions of multiple pages of the MacDonald Codex, or the MacDonald Codex are employed to encrypt data or metadata.

Accordingly, within an embodiment of the invention a page of the MacDonald Codex, a predetermined portion of a page of the MacDonald Codex, multiple pages of the MacDonald Codex, predetermined portions of multiple pages of the MacDonald Codex, or the MacDonald Codex are employed to decrypt data or metadata.

Accordingly, within an embodiment of the invention a page of the MacDonald Codex, a predetermined portion of a page of the MacDonald Codex, multiple pages of the MacDonald Codex, predetermined portions of multiple pages of the MacDonald Codex, or the MacDonald Codex are employed with one or more decision processes relating to data or metadata.

Accordingly, within an embodiment of the invention a page of the MacDonald Codex, a predetermined portion of a page of the MacDonald Codex, multiple pages of the MacDonald Codex, predetermined portions of multiple pages of the MacDonald Codex, or the MacDonald Codex are employed to process data or metadata.

Accordingly, within an embodiment of the invention a page of the MacDonald Codex, a predetermined portion of a page of the MacDonald Codex, multiple pages of the MacDonald Codex, predetermined portions of multiple pages of the MacDonald Codex, or the MacDonald Codex are employed to store data or metadata.

Accordingly, within an embodiment of the invention a page of the MacDonald Codex, a predetermined portion of a page of the MacDonald Codex, multiple pages of the MacDonald Codex, predetermined portions of multiple pages of the MacDonald Codex, or the MacDonald Codex are employed to one or more of encrypt, decrypt, encode, decode, transmit, receive, and process data or metadata associated with at least one of an enterprise, a service provider, a third-party provider, and a user.

Accordingly, within an embodiment of the invention a page of the MacDonald Codex, a predetermined portion of a page of the MacDonald Codex, multiple pages of the MacDonald Codex, predetermined portions of multiple pages of the MacDonald Codex, or the MacDonald Codex are employed to one or more of encrypt, decrypt, encode, decode, transmit, receive, and process data or metadata associated with biometric information and/or user information.

Accordingly, within an embodiment of the invention a page of the MacDonald Codex, a predetermined portion of a page of the MacDonald Codex, multiple pages of the MacDonald Codex, predetermined portions of multiple pages of the MacDonald Codex, or the MacDonald Codex are employed to one or more of encrypt, decrypt, encode, decode, transmit, receive, and process data or metadata associated with electronic content and/or a computer file.

Accordingly, within an embodiment of the invention a page of the MacDonald Codex, a predetermined portion of a page of the MacDonald Codex, multiple pages of the MacDonald Codex, predetermined portions of multiple pages of the MacDonald Codex, or the MacDonald Codex are employed to one or more of encrypt, decrypt, encode, decode, transmit, receive, and process data or metadata associated with a profile associated with at least one of an enterprise, a service provider, a third party provider and a user.

As discussed above embodiments of the invention, for example in respect of FIG. 1, a language, such as Language A comprises trinary representations “+1”, “0” and “−1.” Further, the embodiments of the invention with respect to the MacDonald Codex etc. relate to a ternary to nonary language which can contract and/or expand in multiple forms. For example, referring to Equations (16) to (18) we can convert the ternary −1, 0, +1 to 3, 6, 9 in its ternary translated form. This when expanded from ternary to nonary yields 147, 369, 258 which in its full expanded nonary form is given by Equations (19A) to (19C) respectively.

−1=3=147=123456789 (16)

0=9=369=159483726 (17)

+1=6=258=186429753 (18)

123456789 (19A)

159483726 (19B)

186429753 (19C)

Accordingly, through the embodiments of the invention with respect to the MacDonald Codex can form the basis for quantum computing as they provide for conversion between nonary and ternary languages. Accordingly, quantum states such as spin may exist in +1, 0, −1 representing the ternary language of the quantum computing which once the computing has been performed to yield a ternary language result can be converted to a nonary language.

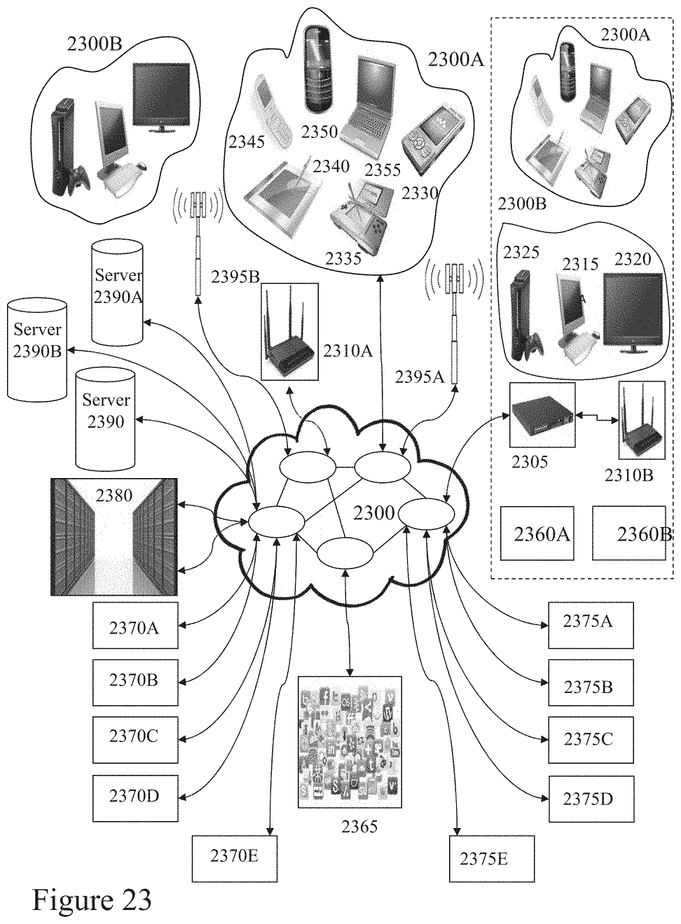

Referring to FIG. 23 there is depicted a network environment 2300 within which embodiments of the invention may be employed supporting Whole Number Mathematical Image on Systems and Financial Transaction Applications/Platforms (FTS-FTAPs) according to embodiments of the invention. Such FTS-FTAPs, for example, supporting multiple communication channels, dynamic filtering, etc. As shown first and second user groups 2300A and 2300B respectively interface to a telecommunications network environment 2300. Within the representative telecommunication architecture, a remote central exchange 2380 communicates with the remainder of a telecommunication service providers network via the network environment 2300 which may include for example long-haul OC-48/OC-192 backbone elements, an OC-48 wide area network (WAN), a Passive Optical Network, and a Wireless Link. The central exchange 2380 is connected via the network environment 2300 to local, regional, and international exchanges (not shown for clarity) and therein through network environment 2300 to first and second cellular APs 2395A and 2395B respectively which provide Wi-Fi cells for first and second user groups 2300A and 2300B, respectively. Also connected to the network environment 2300 are first and second Wi-Fi nodes 2310A and 2310B, the latter of which being coupled to network environment 2300 via router 2305. Second Wi-Fi node 2310B is associated with commercial service provider 2360, e.g., Gillette Stadium™, comprising other first and second user groups 2300A and 2300B. Second user group 2300B may also be connected to the network environment 2300 via wired interfaces including, but not limited to, DSL, Dial-Up, DOC SIS, Ethernet, G.hn, ISDN, MoCA, PON, and Power line communication (PLC) which may or may not be routed through a router such as router 2305.

Within the cell associated with first AP 2310A the first group of users 2300A may employ a variety of PEDs including for example, laptop computer 2355, portable gaming console 2335, tablet computer 2340, smartphone 2350, cellular telephone 2345 as well as portable multimedia player 2330. Within the cell associated with second AP 2310B are the second group of users 2300B which may employ a variety of FEDs including for example gaming console 2325, personal computer 2315 and wireless/Internet enabled television 2320 as well as cable modem 2305. First and second cellular APs 2395A and 2395B respectively provide, for example, cellular GSM (Global System for Mobile Communications) telephony services as well as 3G and 4G evolved services with enhanced data transport support. Second cellular AP 2395B provides coverage in the exemplary embodiment to first and second user groups 2300A and 2300B. Alternatively the first and second user groups 2300A and 2300B may be geographically disparate and access the network environment 2300 through multiple APs, not shown for clarity, distributed geographically by the network operator or operators. First cellular AP 2395A as show provides coverage to first user group 2300A and environment 2370, which comprises second user group 2300B as well as first user group 2300A. Accordingly, the first and second user groups 2300A and 2300B may according to their particular communications interfaces communicate to the network environment 2300 through one or more wireless communications standards such as, for example, IEEE 802.11, IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, and IMT-1000. It would be evident to one skilled in the art that many portable and fixed electronic devices may support multiple wireless protocols simultaneously, such that for example a user may employ GSM services such as telephony and SMS and Wi-Fi/WiMAX data transmission, VOIP and Internet access. Accordingly, portable electronic devices within first user group 2300A may form associations either through standards such as IEEE 802.15 and Bluetooth as well in an ad-hoc manner.

Also connected to the network environment 2300 are Social Networks (SOCNETS) 2365, first and second service providers 2370A and 2370B respectively, e.g. Bank of America™ and CitiGroup™, first and second third party service providers 2370C and 2370D respectively, e.g. Visa™ and MasterCard™. Also connected to the network environment 2300 are first and second retailers 2375A and 2375B respectively, e.g., WalMart™ and Walgreens™ together with first and second retail malls, e.g., Mall of America□ and Millcreek Mall™ together with others, not shown for clarity. Accordingly, an MSME such as first service provider 2370A engages with multiple users, e.g. seller and buyers of residential and/or commercial properties or renters/rentees of rental residential and/or commercial properties as well as other brokers, agents, etc. wherein these may include those within their own organization, e.g. first service provider 2370A (OttawaDreamHouse™), another associated organization, e.g. second service provider 2370B (RE-MAX™), or other service providers such as first and second service providers 2370C and 2370D respectively and first to fourth feed networks 2375A to 2375D respectively. In addition, information relating to properties, the first service provider 2370A, or a specific realtor within first service provider 2370A may be obtained from one or more social networks such as LinkedIn™, Facebook™, etc.

Also depicted are first and second servers 2390A and 2390B may host according to embodiments of the inventions multiple services associated with a provider of contact management systems and contact management applications/platforms (FTS-FTAPs); a provider of a SOCNET or Social Media (SOME) exploiting FTS-FTAP features; a provider of a SOCNET and/or SOME not exploiting FTS-FTAP features; a provider of services to PEDS and/or FEDS; a provider of one or more aspects of wired and/or wireless communications; an Enterprise 2360 such as Multiple Listing Service (MLS) exploiting FTS-FTAP features; license databases; content databases; image databases; content libraries; customer databases; websites; and software applications for download to or access by FEDs and/or PEDs exploiting and/or hosting FTS-FTAP features. First and second primary content servers 2390A and 2390B may also host for example other Internet services such as a search engine, financial services, third party applications and other Internet based services.

Accordingly, a consumer and/or customer (CONCUS) may exploit a PED and/or FED within an Enterprise 2360, for example, and access one of the first or second primary content servers 2390A and 2390B respectively to perform an operation such as accessing/downloading an application which provides FTS-FTAP features according to embodiments of the invention; execute an application already installed providing FTS-FTAP features; execute a web based application providing FTS-FTAP features; or access content. Similarly, a CONCUS may undertake such actions or others exploiting embodiments of the invention exploiting a PED or FED within first and second user groups 2300A and 2300B respectively via one of first and second cellular APs 2395A and 2395B respectively and first Wi-Fi nodes 2310A. It would also be evident that a CONCUS may, via exploiting network environment 2300 communicate via telephone, fax, email, SMS, social media, etc.

Accordingly, FIG. 23 depicts a network environment 2300 wherein one or more parties including, but not limited to, a user, users, an enterprise, enterprises, third party provider, third party providers, wares provider, wares providers, financial registry, financial registries, financial provider, and financial providers may engage in one or more financial transactions relating to an activity including, but not limited to, e-business, P2P, C2B, B2B, C2C, B2G, C2G, P2D, and D2D. Optionally, rather than wired and/or wireless communication interfaces devices may exploit other communication interfaces such as optical communication interfaces and/or satellite communications interfaces.

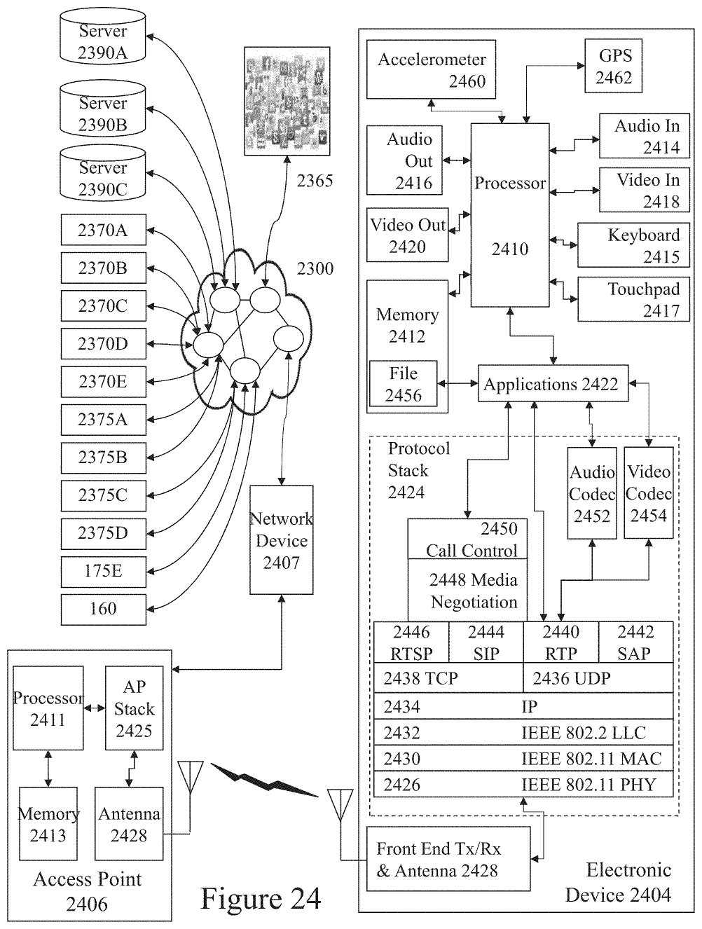

Now referring to FIG. 24 there is depicted an electronic device 2404 and network access point 2407 supporting FTS-FTAP features according to embodiments of the invention. Electronic device 2404 may, for example, be a PED and/or FED and may include additional elements above and beyond those described and depicted. Also depicted within the electronic device 2404 is the protocol architecture as part of a simplified functional diagram of a system 2400 that includes an electronic device 2404, such as a smartphone 2355, an access point (AP) 2406, such as first AP 2310, and one or more network devices 2407, such as communication servers, streaming media servers, and routers for example such as first and second servers 2390A and 2390B, respectively. Network devices 2407 may be coupled to AP 2406 via any combination of networks, wired, wireless and/or optical communication links such as discussed above in respect of FIG. 23 as well as directly as indicated. Network devices 2407 are coupled to network environment 2300 and therein Social Networks (SOCNETS) 2365, first and second service providers 2370A and 2370B respectively, e.g., Bank of America™ and CitiGroup™, first and second third party service providers 2370C and 2370D respectively, e.g. Visa™ and MasterCard™. Also connected to the network environment 2300 are first and second retailers 2375A and 2375B respectively, e.g., WalMart™ and Walgreens™ together with first and second retail malls, e.g. Mall of America™ and Millcreek Mall™, together with others, not shown for clarity.

The electronic device 2404 includes one or more processors 2410 and a memory 2412 coupled to processor(s) 2410. AP 2406 also includes one or more processors 2411 and a memory 2413 coupled to processor(s) 2410. A non-exhaustive list of examples for any of processors 2410 and 2411 includes a central processing unit (CPU), a digital signal processor (DSP), a reduced instruction set computer (RISC), a complex instruction set computer (CISC) and the like. Furthermore, any of processors 2410 and 2411 may be part of application specific integrated circuits (ASICs) or may be a part of application specific standard products (ASSPs). A non-exhaustive list of examples for memories 2412 and 2413 includes any combination of the following semiconductor devices such as registers, latches, ROM, EEPROM, flash memory devices, non-volatile random access memory devices (NVRAM), SDRAM, DRAM, double data rate (DDR) memory devices, SRAM, universal serial bus (USB) removable memory, and the like.

Electronic device 2404 may include an audio input element 2414, for example a microphone, and an audio output element 2416, for example, a speaker, coupled to any of processors 2410. Electronic device 2404 may include a video input element 2418, for example, a video camera or camera, and a video output element 2420, for example an LCD display, coupled to any of processors 2410. Electronic device 2404 also includes a keyboard 2415 and touchpad 2417 which may for example be a physical keyboard and touchpad allowing the user to enter content or select functions within one of more applications 2422. Alternatively, the keyboard 2415 and touchpad 2417 may be predetermined regions of a touch sensitive element forming part of the display within the electronic device 2404. The one or more applications 2422 that are typically stored in memory 2412 and are executable by any combination of processors 2410. Electronic device 2404 also includes accelerometer 2460 providing three-dimensional motion input to the process 2410 and GPS 2462 which provides geographical location information to processor 2410.

Electronic device 2404 includes a protocol stack 2424 and AP 2406 includes a communication stack 2425. Within system 2400 protocol stack 2424 is shown as IEEE 802.11 protocol stack but alternatively may exploit other protocol stacks such as an Internet Engineering Task Force (IETF) multimedia protocol stack for example. Likewise, AP stack 2425 exploits a protocol stack but is not expanded for clarity. Elements of protocol stack 2424 and AP stack 2425 may be implemented in any combination of software, firmware and/or hardware. Protocol stack 2424 includes an IEEE 802.11-compatible PHY module 2426 that is coupled to one or more Front-End Tx/Rx & Antenna 2428, an IEEE 802.11-compatible MAC module 2430 coupled to an IEEE 802.2-compatible LLC module 2432. Protocol stack 2424 includes a network layer IP module 2434, a transport layer User Datagram Protocol (UDP) module 2436 and a transport layer Transmission Control Protocol (TCP) module 2438.

Protocol stack 2424 also includes a session layer Real Time Transport Protocol (RTP) module 2440, a Session Announcement Protocol (SAP) module 2442, a Session Initiation Protocol (SIP) module 2444 and a Real Time Streaming Protocol (RTSP) module 2446. Protocol stack 2424 includes a presentation layer media negotiation module 2448, a call control module 2450, one or more audio codecs 2452 and one or more video codecs 2454. Applications 2422 may be able to create maintain and/or terminate communication sessions with any of devices 2407 by way of AP 2406. Typically, applications 2422 may activate any of the SAP, SIP, RTSP, media negotiation and call control modules for that purpose. Typically, information may propagate from the SAP, SIP, RTSP, media negotiation and call control modules to PHY module 2426 through TCP module 2438, IP module 2434, LLC module 2432 and MAC module 2430.

It would be apparent to one skilled in the art that elements of the electronic device 2404 may also be implemented within the AP 2406 including but not limited to one or more elements of the protocol stack 2424, including for example an IEEE 802.11-compatible PHY module, an IEEE 802.11-compatible MAC module, and an IEEE 802.2-compatible LLC module 2432. The AP 2406 may additionally include a network layer IP module, a transport layer User Datagram Protocol (UDP) module and a transport layer Transmission Control Protocol (TCP) module as well as a session layer Real Time Transport Protocol (RTP) module, a Session Announcement Protocol (SAP) module, a Session Initiation Protocol (SIP) module and a Real Time Streaming Protocol (RTSP) module, media negotiation module, and a call control module. Portable and fixed electronic devices represented by electronic device 2404 may include one or more additional wireless or wired interfaces in addition to the depicted IEEE 802.11 interface which may be selected from the group comprising IEEE 802.15, IEEE 802.16, IEEE 802.20, UMTS, GSM 850, GSM 900, GSM 1800, GSM 1900, GPRS, ITU-R 5.138, ITU-R 5.150, ITU-R 5.280, IMT-1000, DSL, Dial-Up, DOCSIS, Ethernet, G.hn, ISDN, MoCA, PON, and Power line communication (PLC).

Accordingly, FIG. 24 depicts an Electronic Device 2404, e.g. a PED, wherein one or more parties including, but not limited to, a user, users, an enterprise, enterprises, third party provider, third party providers, wares provider, wares providers, financial registry, financial registries, financial provider, and financial providers may engage in one or more financial transactions relating to an activity including, but not limited to, e-business, P2P, C2B, B2B, C2C, B2G, C2G, P2D, and D2D via the network environment 2300 using the electronic device or within either the access point 2406 or network device 2407 wherein details of the transaction are then coupled to the network environment 2300 and stored within remote servers.

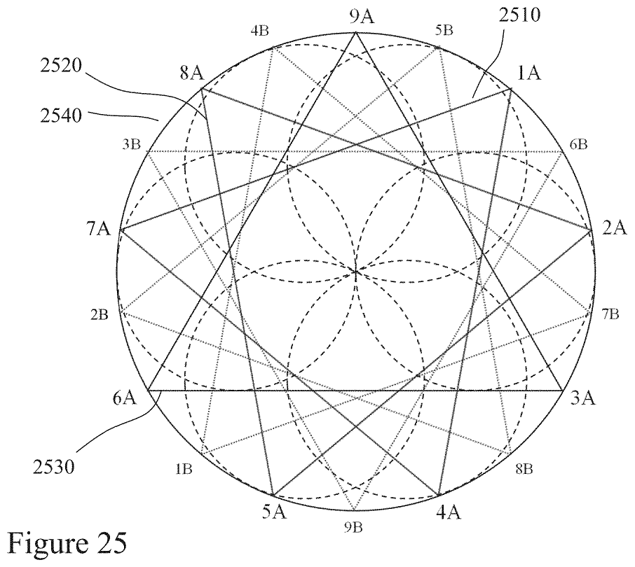

Referring to FIG. 25 there is depicted a configuration of an electrical motor exploiting embodiments of the invention. As depicted a circle 2540 has defined around it a series of major nodes 1A to 9A respectively in a clockwise direction starting with 1A at 40° and ending at 9A at 360°. Also depicted are a second sequence of minor nodes 1B to 9B respectively starting at 220° and ending at 180°. Considering the sequences 147, 258, and 369 then with the first sequence 147 consider a first series of magnets each disposed at major nodes 1A, 4A, and 7A (147) then we obtain a first triangle 2510 connecting major points 1A, 4A, and 7A which represents the ascending side of the circle 2540. With the second sequence 258 then with a second series of magnets each disposed at the major nodes 2A, 5A, and 8A then we obtain a second triangle 2520 connecting major nodes 2A, 5A and 8A which represents the descending side of the circle. Accordingly, a third triangle 2530 of the sequence 369 is also depicted joining the major nodes 3A, 6A and 9A representing a neutral series between the first sequence 147 and 258.

If we assume that negative is on the ascending points and positive is one the descending nodes then accordingly, a motor exploiting an embodiment of the invention may be wound as follows with first to fourth coil sets, Coil Set A, Coil Set B, Coil Set C and Coil Set D respectively:

Coil Set A comprising:
Negative wire at node 1A at 40°;
Negative wire at node 4A at 160°;
Negative wire at node 7A at 280°;

Coil Set B comprising:
Positive wire at node 2A at 80°;
Positive wire at node 5A at 200°;
Positive wire at node 8A at 320°;

Coil Set C comprising:
Negative wire at node 1B at 220°;
Negative wire at node 4B at 340°;
Negative wire at node 7B at 100°;

Coil Set D comprising:
Positive wire at node 2B at 260°;
Positive wire at node 5B at 20°;
Positive wire at node 8B at 140°;

The coils within each of first to fourth coil sets, Coil Set A, Coil Set B, Coil Set C and Coil Set D respectively, may be individual coils or a combined coil.

The inventor notes that the universe is six dimensional, in fact a six dimensional non conformal field theory universe, in that it is a four-dimensional physical universe (three spatial dimensions and time) with the addition of a pair of metaphysical dimensions. Accordingly, for each pair of universes a third universe can be created, so the 2^{nd} universe equals the 3^{rd} universe, and the 4^{th} universe equals the 6^{th} universe. Accordingly, the inventor notes that our reality is the 5^{th} universe of the 6 universes and that the second universe is what is referred to as an “opposing” earth. Based upon their analysis the inventor associates a pair of these 6 universes as dark universes and another pair as light universes. These universes being listed as sequences 1 to 6 of the MacDonald Codex as described and depicted above in respect of FIGS. 3 to 22, respectively. Accordingly, the numerical paths/sequences within the MacDonald codex define a resonant sequence to establish an opening or portal between one universe to another by matching the universe with its numerical sequence.

Optionally, rather than wired and/or wireless communication interfaces devices may exploit other communication interfaces such as optical communication interfaces and/or satellite communications interfaces. Optical communications interfaces may support Ethernet, Gigabit Ethernet, SONET, Synchronous Digital Hierarchy (SDH) etc.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps, and means described above may be done in various ways. For example, these techniques, blocks, steps, and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above and/or a combination thereof.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be rearranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages and/or any combination thereof. When implemented in software, firmware, middleware, scripting language and/or microcode, the program code or code segments to perform the necessary tasks may be stored in a machine-readable medium, such as a storage medium. A code segment or machine-executable instruction may represent a procedure, a function, a subprogram, a program, a routine, a subroutine, a module, a software package, a script, a class, or any combination of instructions, data structures and/or program statements. A code segment may be coupled to another code segment or a hardware circuit by passing and/or receiving information, data, arguments, parameters and/or memory content. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor and may vary in implementation where the memory is employed in storing software codes for subsequent execution to that when the memory is employed in executing the software codes. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, wireless channels and/or various other mediums capable of storing, containing, or carrying instruction(s) and/or data.

The methodologies described herein are, in one or more embodiments, performable by a machine which includes one or more processors that accept code segments containing instructions. For any of the methods described herein, when the instructions are executed by the machine, the machine performs the method. Any machine capable of executing a set of instructions (sequential or otherwise) that specify actions to be taken by that machine are included. Thus, a typical machine may be exemplified by a typical processing system that includes one or more processors. Each processor may include one or more of a CPU, a graphics-processing unit, and a programmable DSP unit. The processing system further may include a memory subsystem including main RAM and/or a static RAM, and/or ROM. A bus subsystem may be included for communicating between the components. If the processing system requires a display, such a display may be included, e.g., a liquid crystal display (LCD). If manual data entry is required, the processing system also includes an input device such as one or more of an alphanumeric input unit such as a keyboard, a pointing control device such as a mouse, and so forth.

The memory includes machine-readable code segments (e.g., software or software code) including instructions for performing, when executed by the processing system, one of more of the methods described herein. The software may reside entirely in the memory, or may also reside, completely or at least partially, within the RAM and/or within the processor during execution thereof by the computer system. Thus, the memory and the processor also constitute a system comprising machine-readable code.

In alternative embodiments, the machine operates as a standalone device or may be connected, e.g., networked to other machines, in a networked deployment, the machine may operate in the capacity of a server or a client machine in server-client network environment, or as a peer machine in a peer-to-peer or distributed network environment. The machine may be, for example, a computer, a server, a cluster of servers, a cluster of computers, a web appliance, a distributed computing environment, a cloud computing environment, or any machine capable of executing a set of instructions (sequential or otherwise) that specify actions to be taken by that machine. The term “machine” may also be taken to include any collection of machines that individually or jointly execute a set (or multiple sets) of instructions to perform any one or more of the methodologies discussed herein.

The foregoing disclosure of the exemplary embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system comprising:
a microprocessor;
a non-volatile, non-transitory storage medium storing computer executable instructions; wherein
the computer executable instructions when executed by the microprocessor automatically execute one or more processes upon data accessible to the microprocessor; and
each process of the one or more processes employs a predetermined portion of a codex.

2. The system according to claim 1, wherein
the predetermined portion of the codex is either:
a whole number mathematical image representation;
or:
a plurality of S lower sequences and a plurality T threads wherein each lower sequence of the plurality of S lower sequences and each thread of the plurality T threads comprises a recurring sequence of nine numbers where each number is an integer N, 0≤N≤9, S=6 and T=3.

3. The system according to claim 1, wherein
the codex is a whole number mathematical image representation.

4. The system according to claim 1, wherein
the codex comprises six lower sequences and three threads; wherein
each lower sequence of the six lower sequences and each thread of the three threads comprises a recurring sequence of nine numbers;
each number is an integer N; and
0≤N≤9.

5. The system according to claim 1, wherein
the codex comprises six sequences and three threads; wherein
each lower sequence of the six lower sequences and each thread of the three threads comprises a recurring sequence;
each thread of the three threads comprises nine numbers where each number is an integer N and 0≤N≤9;
a first lower sequence of the six lower sequences has the recurring sequence 1,2,3,4,5,6,7,8,9;
a second lower sequence of the six lower sequences has the recurring sequence 3,7,2,6,1,5,8,4,8;
a third lower sequence of the six lower sequences has the recurring sequence 1,8,6,4,2,9,7,5,3;
a fourth lower sequence of the six lower sequences has the recurring sequence 9,1,2,3,4,5,6,7,8;
a fifth lower sequence of the six lower sequences has the recurring sequence 1,5,9,4,8,3,7,2,6; and
a sixth lower sequence of the six lower sequences has the recurring sequence 6,4,2,9,7,5,3,1,8.

6. The system according to claim 1, wherein
the codex comprises six sequences and three threads; wherein
each lower sequence of the six lower sequences and each thread of the three threads comprises a recurring sequence;
each lower sequence of the six lower sequence comprises nine numbers where each number is an integer N and 0≤N≤9;
a first thread of the three threads has the recurring sequence 1,2,3,4,5,6,7,8,9;
a second thread of the three threads has the recurring sequence 1,8,6,4,2,9,7,5,3; and
a third thread of the three threads has the recurring sequence 1,5,9,4,8,3,7,2,6.

7. A non-volatile, non-transitory storage medium storing computer executable instructions for execution by a microprocessor, the computer executable instructions when executed by the microprocessor configuring the microprocessor to:
automatically execute one or more processes upon data accessible to the microprocessor; wherein
each process of the one or more processes employs a predetermined portion of a codex.

8. The system according to claim 7, wherein
the predetermined portion of the codex is either:
a whole number mathematical image representation;
or:
a plurality of S lower sequences and a plurality T threads wherein each lower sequence of the plurality of S lower sequences and each thread of the plurality T threads comprises a recurring sequence of nine numbers where each number is an integer N, 0≤N≤9, S=6 and T=3.

9. The system according to claim 7, wherein
the codex is a whole number mathematical image representation.

10. The system according to claim 7, wherein
the codex comprises six lower sequences and three threads; wherein
each lower sequence of the six lower sequences and each thread of the three threads comprises a recurring sequence of nine numbers;
each number is an integer N; and
0≤N≤9.

11. The system according to claim 7, wherein
the codex comprises six sequences and three threads; wherein
each lower sequence of the six lower sequences and each thread of the three threads comprises a recurring sequence;
each thread of the three threads comprises nine numbers where each number is an integer N and 0≤N≤9;
a first lower sequence of the six lower sequences has the recurring sequence 1,2,3,4,5,6,7,8,9;
a second lower sequence of the six lower sequences has the recurring sequence 3,7,2,6,1,5,8,4,8;
a third lower sequence of the six lower sequences has the recurring sequence 1,8,6,4,2,9,7,5,3;
a fourth lower sequence of the six lower sequences has the recurring sequence 9,1,2,3,4,5,6,7,8;
a fifth lower sequence of the six lower sequences has the recurring sequence 1,5,9,4,8,3,7,2,6; and
a sixth lower sequence of the six lower sequences has the recurring sequence 6,4,2,9,7,5,3,1,8.

12. The system according to claim 7, wherein
the codex comprises six sequences and three threads; wherein
each lower sequence of the six lower sequences and each thread of the three threads comprises a recurring sequence;
each lower sequence of the six lower sequence comprises nine numbers where each number is an integer N and 0≤N≤9;
a first thread of the three threads has the recurring sequence 1,2,3,4,5,6,7,8,9;
a second thread of the three threads has the recurring sequence 1,8,6,4,2,9,7,5,3; and
a third thread of the three threads has the recurring sequence 1,5,9,4,8,3,7,2,6.
